(19) United States
(12) Patent Application Publication
(10) Pub. No.: US 2019/0206117 A1
(43) Pub. Date: Jul. 4, 2019

(54) IMAGE PROCESSING METHOD, INTELLIGENT TERMINAL, AND STORAGE DEVICE

(71) Applicant: UBTECH ROBOTICS CORP., Shenzhen (CN)

(72) Inventors: Youjun XIONG, Shenzhen (CN); Shengqi Tan, Shenzhen (CN); Cihui Pan, Shenzhen (CN); Xianji Wang, Shenzhen (CN); Jianxin Pang, Shenzhen (CN)

(21) Appl. No.: 16/231,978

(22) Filed: Dec. 25, 2018

(30) Foreign Application Priority Data
Dec. 29, 2017 (CN) 201711498745.5

(51) Int. Cl. G06T 15/20; G06T 5/00; G06T 7/194; G06T 5/50

(52) U.S. Cl. CPC G06T 15/205; G06T 5/002; G06T 2207/10028; G06T 5/50; G06T 2207/20221; G06T 7/194

(57) ABSTRACT

The present disclosure provides an image processing method, an intelligent terminal, and a storage device. The image processing method may include: obtaining an original image, and obtaining mask information of a target object from the original image, wherein the mask information includes classification information for foreground and background of the target object; denoising the original image to obtain a denoised image of the original image; and obtaining a target image from the denoised image according to the mask information of the target object. The present disclosure can improve the quality of the image by denoising the original image, and the obtained target image can be a minimum-sized image including all the information of the target object. Because the size of the image is reduced without losing valid information, the calculation amount of the 3D synthesis can be greatly reduced.

### CROSS-REFERENCE TO RELATED APPLICATION

This application claims priority to Chinese Patent Application No. 201711498745.5, filed on Dec. 29, 2017, the contents of which are herein incorporated by reference in its entirety.

### TECHNICAL FIELD

The present disclosure relates to the field of image processing, and more particularly, to an image processing method, an intelligent terminal, and a storage device.

### BACKGROUND

Structure from motion (SFM) and multi-view stereo vision (MVS) are traditional three-dimensional (3D) reconstruction methods, and are used for calculating 3D information from multiple two-dimensional (2D) images. For traditional vision-based 3D reconstruction, when it is necessary to reconstruct a high-precision 3D model, there are higher requirements to shooting environment and qualities of captured images. For example, a large number of high-definition images are often needed to be captured from multiple different angles, and a clean background is also needed. It takes a lot of time to prepare these images, and a large number of high-resolution images may cause 3D reconstruction process to be extremely slow. Therefore, high requirements for computing resources are existed.

At present, there are some scenes that urgently require a simple and fast 3D reconstruction method. For example, an e-commerce platform hopes to display a 3D model of a product on its web page for user's to browse. If a traditional multi-view stereo vision is used to reconstruct a high-quality 3D model of the product, a professional studio for shooting is required, and a better computing platform for 3D reconstruction is required. This requires a large price and is not conducive to the promotion and application of technology.

Therefore, it is necessary to provide an image processing method for 3D reconstruction to solve the above technical problem.

### SUMMARY

The present disclosure provides an image processing method, an intelligent terminal and a storage device, which can achieve a minimum-sized image including all information of a target object, and simultaneously improve quality of the image, thereby greatly reducing calculation amount of 3D reconstruction.

In an aspect, an image processing method is provided. The image processing method may include: obtaining an original image, and obtaining mask information of a target object from the original image, wherein the mask information includes classification information for foreground and background of the target object; denoising the original image to obtain a denoised image of the original image; and obtaining a target image from the denoised image according to the mask information of the target object.

In another aspect, an intelligent terminal is provided. The intelligent terminal may include a processor and a human-machine interaction device coupled to each other. The processor, when working, cooperates with the human-machine interaction device to implement operations in the method described above.

In another aspect, a storage device is provided. The storage device may store program data, and the program data is executable to implement operations in the method described above.

The present disclosure may have the following benefits. Different from the prior art, the present disclosure can improve the quality of the image by denoising the original image, and the obtained target image can be a minimum-sized image including all information of the target object. Because the size of the image is reduced without losing valid information, calculation amount of 3D synthesis can be greatly reduced.

### BRIEF DESCRIPTION OF THE DRAWINGS

FIG. 1 is a schematic flow chart of an embodiment of an image processing method provided by the present disclosure.

FIG. 2 is a schematic image processing diagram of the image processing method of FIG. 1.

FIG. 3 is a schematic structural diagram of an embodiment of an intelligent terminal provided by the present disclosure.

FIG. 4 is a schematic structural diagram of an embodiment of a storage device provided by the present disclosure.

### DETAILED DESCRIPTION

Technical solutions in embodiments of the present disclosure will be clearly and completely described in the following with reference to drawings. It is obvious that the described embodiments are only a part of the present disclosure, not all embodiments. Based on the embodiments in the present disclosure, all other embodiments obtained by those of ordinary skill in the art without creative efforts are within protection scopes of the present disclosure.

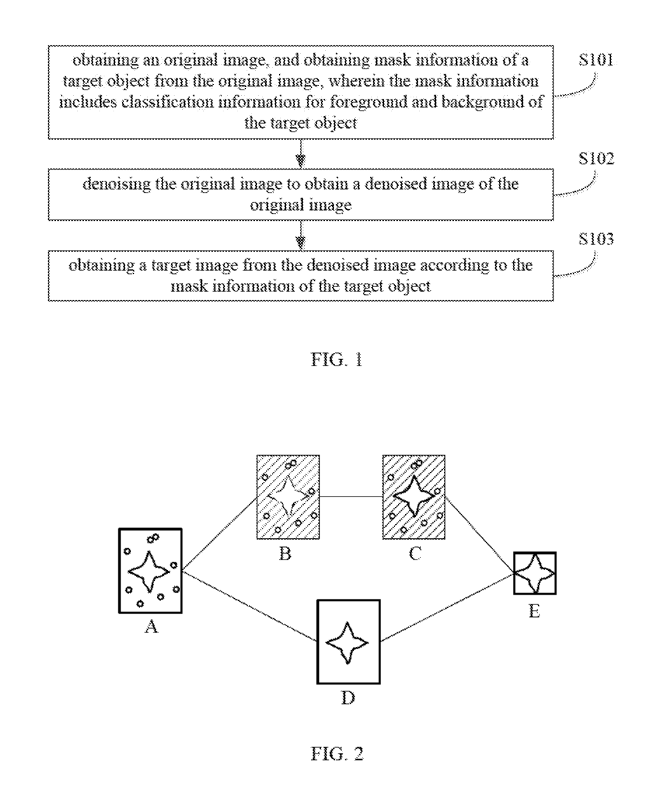

In order to obtain a target image of a target object, the present disclosure performs denoising on an original image, obtains mask information including classification information for foreground and background from the original image, and obtains the target image from the denoised image according to the mask information. The target image of the present disclosure is a minimum-sized image including all information of the target object, and quality of the target image is improved compared to the original image. Hereinafter, an image processing method of the present disclosure will be described in detail with reference to FIGS. 1 and 2.

Referring to FIG. 1, a schematic flow chart of an embodiment of the image processing method provided by the present disclosure is shown. The image processing method mainly includes the following operations.

S101: obtaining an original image, and obtaining mask information of a target object from the original image, wherein the mask information includes classification information for foreground and background of the target object.

The original image is an original 2D image of the target object captured from an angle, and may include the target object and the background. An intelligent terminal may shoot the target object from a plurality of different angles to obtain a plurality of original images of the target object. In an embodiment, the intelligent terminal is a smart camera. In other embodiments, the intelligent terminal may be a smart phone, a tablet computer, a laptop computer, or the like.

Specifically the intelligent terminal may obtain initial mask information of the target object from the original image. In an optional implementation manner, the initial mask information may include classification information for initial foreground and background of the target object. It may need to determine whether the classification information for the initial foreground and background is accurate because, in most cases, there may be inaccurate classification information. Fusion calculation may be performed on the initial mask information and the original image, so that the inaccurate classification information may be corrected based on the original image, thereby obtaining mask information including accurate classification information for the foreground and background.

In order to clearly illustrate the above embodiments, FIG. 2 is referred. FIG. 2 shows a schematic image processing diagram of the image processing method of FIG. 1. As an example, the target object is illustrated as a flower. An original image A containing the target object (i.e., the flower) and the background is captured using a smart camera or other smart device. The flower in the original image A is the foreground, and other portion in the original image A except for the flower is the background. Feature information of the target object (i.e., the flower) is extracted from the original image A. The feature information may be extracted by using a pre-trained model based on the image recognition database ImageNet or using a customized base network trained via the image recognition database ImageNet. The feature information may include color of the target object (i.e., the flower), the classification information for the foreground and the background, and texture information of the background. In another embodiment, the feature information may further include other feature information of the target object, such as a shape, etc. According to the extracted feature information, the image space structure is inferred through a network layer such as a deconvolution layer, so that each pixel in the original image is classified as the foreground or the background. The classification of each pixel in the original image A is determined, wherein the pixel belonging to the flower is the foreground portion, and the pixel other than the flower belongs to the background portion. Accordingly, initial mask information B of the target object (i.e., the flower) is obtained. In the initial mask information B, there may be pixels with inaccurate foreground and background classification. Fusion calculation may be performed on the initial mask information B and the original image A, so that pixels with inaccurate foreground and background classification may be corrected based on the original image A, thereby obtaining mask information C including accurate classification. As shown in FIG. 2, the padding areas in the initial mask information B and the mask information C represent background portions.

In other embodiments, the mask information C can also be directly obtained from the original image A, which is not specifically limited herein.

S102: denoising the original image to obtain a denoised image of the original image.

Images are often affected by imaging equipment and external environmental noises during digitization and transmission. These images become noise images. The original image may contain noises, which may affect the quality of the image. In order to improve the image quality, these noises need to be removed. In this embodiment, the original image is denoised by a neural network calculation method to obtain the denoised image of the original image. The size of the denoised image and the size of the original image are the same. In other embodiments, denoising can also be performed in other ways, such as removing noises through a filter. Specifically, the present embodiment performs denoising through network parameter training, wherein training data set can be obtained by simulation.

As shown in FIG. 2, the original image A contains noises, and the small circles in FIG. 2 represent the noises. The original image A may be denoised by the neural network calculation method to obtain a denoised image D of the original image A. As can be seen from FIG. 2, the qualify of the denoised image D is improved compared to the original image A.

S103: obtaining a target image from the denoised image according to the mask information of the target object.

The mask information and the denoised image are respectively obtained in operations S101 and S102, and operation S103 removes the background from the denoised image according to the classification information for the foreground and the background in the mask information so as to obtain the target image. The size of the target image is not larger than the size of the original image. Specifically, the background removal may be trained, and background removal training data may be a public data set. Alternatively, the background removal may be accomplished by taking image in person and marking it.

As further shown in FIG. 2, the foreground portion of the mask information C is the target object (i.e., the flower). The pixel values of the foreground portion and the background portion are 1 and 0, respectively. The background portion with the pixel value of 0 represents unwanted information, and the pixel value of 1 represents the required effective information. The unwanted background portion is removed from the denoised image D according to the mask information C, thereby obtaining a target image E. The size of the target image E is generally smaller than that of the original image A.

In another embodiment, the above operations are repeated to obtain a plurality of 2D target images of the target object captured from different angles. Then, a 3D image of the target object may be synthesized according to the obtained plurality of 2D target images.

Different from the prior art, the present disclosure can improve the qualify of the image by denoising the original image, and the obtained target image can be a minimum-sized image including all the information of the target object. Because the size of the target image is reduced without losing valid information, the calculation amount of the 3D synthesis can be greatly reduced.

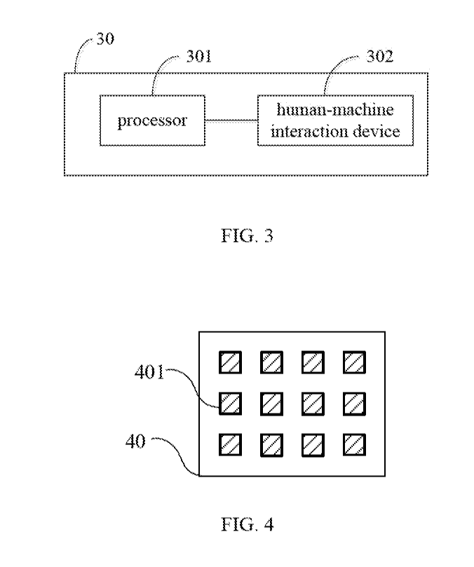

Referring to FIG. 3, a schematic structural diagram of an embodiment of an intelligent terminal provided by the present disclosure is shown. The intelligent terminal 30 includes a processor 301 and a human-machine interaction device 302. The processor 301 is coupled to the human-machine interaction device 302. The human-machine interaction device 302 is configured to perform human-machine interaction with a user. The processor 301 is configured to respond and process according to user selection perceived by the human-machine interaction device 302, and to control the human-machine interaction device 302 to notify the user that the processing has been completed or the current processing status.

The original image is an original 2D image of the target object captured from an angle, and may include the target object and the background. The intelligent terminal 30 may shoot the target object from a plurality of different angles to obtain a plurality of original images of the target object. In an embodiment, the intelligent terminal 30 is a smart camera. In other embodiments, the intelligent terminal 30 may be a smart phone, a tablet computer, a laptop computer, or the like.

Specifically, the processor 301 is configured to obtain initial mask information of the target object from the original image. In an optional implementation manner, the initial mask information may include classification information for foreground and background. The processor 301 may determine whether the classification information for the foreground and background included in the initial mask information is accurate because, in most cases, there may be inaccurate classification information. The processor 301 may perform fusion calculation on the classification information for the initial foreground and background and the original image, so that the inaccurate classification information may be corrected based on the original image, thereby obtaining mask information including accurate classification information for the foreground and background.

Further referring to FIG. 2, the target object is illustrated as a flower. An original image A containing the target object (i.e., the flower) and background is captured using a smart camera or other smart device. The flower in the original image A is the foreground portion, and other portion in the original image A except for the flower is the background. The processor 301 is configured to extract feature information of the target object (i.e., the flower) from the original image A. The feature information may be extracted by using a pre-trained model based on the image recognition database ImageNet or using a customized base network trained via the image recognition database ImageNet. The feature information may include color of the target object (i.e., the flower), the classification information for the foreground and the background, and texture information of the background. In another embodiment, the feature information may further include other feature information of the target object, such as a shape, etc. According to the extracted feature information, the processor 301 may infer the image space structure through a network layer such as a deconvolution layer, so that the foreground and the background are classified and the initial mask information B including the classification information for the initial foreground and background is hereby obtained. In the initial mask information B, there may be inaccurate classification information for the foreground and background. Fusion calculation may be performed on the initial mask information B and the original image A, so that the inaccurate classification information in the initial mask information may be corrected based on the original image A, thereby obtaining mask information C including accurate classification information. As shown in FIG. 2, the padding areas in the initial mask information B and the mask information C represent the background portions.

In other embodiments, the processor 301 can also directly obtain the mask information C from the original image A, which is not specifically limited herein.

Images are often affected by imaging equipment and external environmental noises during digitization and transmission. These images become noise images. The original image may contain noises, which may affect the quality of the image. In order to improve the image quality, these noises need to be removed. In this embodiment, the processor 301 is configured to denoise the original image by a neural network calculation method to obtain a denoised image of the original image. The size of the denoised image and the size of the original image are the same. In other embodiments, denoising can also be performed in other ways, such as removing noises through a filter. Specifically, the present embodiment performs denoising through network parameter training, wherein training data set can be obtained by simulation.

Still as shown in FIG. 2, the original image A contains noises, and the small circles in FIG. 2 represent the noises. The processor 301 may denoise the original image A through the neural network calculation method to obtain a denoised image D of the original image A. As can be seen from FIG. 2, the quality of the denoised image D is improved compared to the original image A.

The processor 301 if configured to remove the background from the denoised image according to the classification information for the foreground and the background in the mask information so as to obtain the target image. The size of the target image is not larger than the size of the original image. Specifically, the processor 301 may train the background removal. The background removal training data may be a public data set. Alternatively, the background removal may be accomplished by taking image in person and marking it.

As further shown in FIG. 2, the foreground portion of the mask information C is the target object (i.e., the flower). The pixel values of the foreground portion and the background portion are 1 and 0, respectively. The background portion with the pixel value of 0 represents unwanted information, and the pixel value of 1 represents the required effective information. The processor 301 may remove the unwanted background portion from the denoised image D according to the mask information C, thereby obtaining the target image E. The size of the target image E is generally smaller than that of the original image A.

In another embodiment, the human-machine interaction device 302 may receive an instruction to synthesize a 3D image, and the processor 301 may repeat the above operations to obtain a plurality of 2D target images of the target object captured from different angles. Then, the 3D image of the target object may be synthesized according to the obtained plurality of 2D target images.

Different from the prior art, the present disclosure can improve the quality of the image by denoising the original image, and the obtained target image can be a minimum-sized image including all the information of the target object. Because the size of the target image is reduced without losing valid information, the calculation amount of the 3D synthesis can be greatly reduced.

Referring to FIG. 4, a schematic structural diagram of an embodiment of a storage device provided by the present disclosure is shown. The storage device 40 may store at least one program or instruction 401. The program or instruction 401 is executable to implement any of the above-described processing information methods. In one embodiment, the storage device may be a storage device in mobile equipment.

In the embodiments provided by the present disclosure, it should be understood that the disclosed method and device may be implemented in other manners. For example, the device embodiments described above are merely illustrative. For example, the division of modules or units is only one logical function division, and in actual implementation there may be another division manner; for example, multiple units or components may be combined or integrated into another system, or some features may be ignored or not executed. In addition, the coupling or communication connection between components shown or discussed herein may be an indirect coupling or communication connection through some interface, device or unit, and may be electrical, mechanical or otherwise.

The units described as separate parts may or may not be physically separated, and the parts shown as units may or may not be physical units, that is, may be located in one position, or may also be distributed on a plurality of network units. A part of or all of the units may be selected according to actual needs to achieve the objectives of the solutions of the embodiments.

In addition, functional units in the embodiments of the present application may be integrated into one processing unit, or each of the units may exist alone physically, or two or more units may be integrated into one unit. The above integrated unit may be implemented in the form of hardware or in the form of a software functional unit.

When the integrated unit is implemented in the form of a software functional unit and sold or used as an independent product, the integrated unit may be stored in a computer-readable storage medium. Based on such an understanding, the essential part of the technical solutions of the present application, or the inventive part compared to the prior art, or all or part of the technical solutions may be implemented in the form of a software product. The computer software product is stored in a storage medium and includes several instructions for instructing a computer device (which may be a personal computer, a server, or a network device) or a processor to perform all or part of the operations of the methods described in the embodiments of the present application. The foregoing storage medium includes any medium that can store program code, such as a USB flash disk, a removable hard disk, a read-only memory (ROM), a random access memory (RAM), a magnetic disk, an optical disc, or the like.

The present disclosure has the following benefits. Different from the prior art, the present disclosure can improve the quality of the image by denoising the original image, and the obtained target image can be a minimum-sized image including all the information of the target object. Because the size of the target image is reduced without losing valid information, the calculation amount of the 3D synthesis can be greatly reduced.

The foregoing descriptions are merely specific implementation manners of the present application, but are not intended to limit the protection scope of the present application. Any variation or replacement readily figured out by a person skilled in the art within the technical scope disclosed in the present application shall fall within the protection scope of the present application. Therefore, the protection scope of the present application shall be subject to the protection scope of the claims.

What is claimed is:

1. An image processing method, comprising:
obtaining an original image, and obtaining mask information of a target object from the original image, wherein the mask information comprises classification information for foreground and background of the target object;
denoising the original image to obtain a denoised image of the original image; and
obtaining a target image from the denoised image according to the mask information of the target object.

2. The image processing method according to claim 1, wherein the obtaining an original image and obtaining mask information of a target object from the original image comprises:
obtaining the original image, and obtaining initial mask information of the target object from the original image, wherein the initial mask information comprises classification information for initial foreground and background of the target object; and
performing fusion calculation on the initial mask information and the original image, and determining the mask information of the target object.

3. The image processing method according to claim 2, wherein the performing fusion calculation on the initial mask information and the original image and determining the mask information of the target object comprises:
determining whether the classification information for the initial foreground and background is accurate; and
when the classification information is inaccurate, performing fusion calculation on the initial mask information and the original image, collecting the inaccurate classification information for the foreground and background based on the original image, and obtaining the mask information of the target object.

4. The image processing method according to claim 1, wherein the obtaining an original image and obtaining mask information of a target object from the original image comprises:
obtaining the original image;
extracting feature information of the target object from the original image; and
classifying each pixel in the original image as the foreground or the background according to the feature information, and determining the classification of each pixel in the original image;
wherein the obtaining a target image from the denoised image according to the mask information of the target object comprises;
obtaining the target image from the denoised image according to the classification of each pixel in the original image, wherein the size of the target image is not larger than the size of the original image.

5. The image processing method according to claim 4, wherein the obtaining the target image from the denoised image according to the classification of each pixel in the original image comprises:
removing the background from the denoised image, and obtaining the target image.

6. The image processing method according to claim 2, wherein the obtaining an original image and obtaining mask information of a target object from the original image comprises:
obtaining the original image;
extracting feature information of the target object from the original image; and
classifying each pixel in the original image as the foreground or the background according to the feature information, and determining the classification of each pixel in the original image;
wherein the obtaining a target image from the denoised image according to the mask information of the target object comprises:
obtaining the target image from the denoised image according to the classification of each pixel in the original image, wherein the size of the target image is not larger than the size of the original image.

7. The image processing method according to claim 6, wherein the obtaining the target image from the denoised image according to the classification of each pixel in the original image comprises:
removing the background from the denoised image, and obtaining the target image.

8. The image processing method according to claim 1, wherein the denoising the original image to obtain a denoised image of the original image comprises:
denoising the original image through a neural network calculation method to obtain the denoised image of the original image.

9. The image processing method according to claim 1, wherein, after obtaining the target image from the denoised image according to the mask information of the target object, the image processing method further comprises:
synthesizing a 3D image of the target object according to a plurality of 2D target images of the target object.

10. The image processing method according to claim 9, wherein the plurality of 2D target images are captured from different angles.

11. An intelligent terminal, comprising:
a processor and a human-machine interaction device coupled to each other; wherein the processor, when working, cooperates with the human-machine interaction device to implement the following operations:
obtaining an original image, and obtaining mask information of a target object from the original image, wherein the mask information comprises classification information for foreground and background of the target object;
denoising the original image to obtain a denoised image of the original image; and
obtaining a target image from the denoised image according to the mask information of the target object.

12. The intelligent terminal according to claim 11, wherein the obtaining an original image and obtaining mask information of a target object from the original image comprises:
obtaining the original image, and obtaining initial mask information of the target object from the original image, wherein the initial mask information comprises classification information for initial foreground and background of the target object; and
performing fusion calculation on the initial mask information and the original image, and determining the mask information of the target object.

13. The intelligent terminal according to claim 12, wherein the performing fusion calculation on the initial mask information and the original image and determining the mask information of the target object comprises:
determining whether the classification information for the initial foreground and background is accurate; and
when the classification information is inaccurate, performing fusion calculation on the initial mask information and the original image, correcting the inaccurate classification information for the foreground and background based on the original image, and obtaining the mask information of the target object.

14. The intelligent terminal according to claim 11, wherein the obtaining an original image and obtaining mask information of a target object from the original image comprises:
obtaining the original image;
extracting feature information of the target object from the original image; and
classifying each pixel in the original image as the foreground or the background according to the feature information, and determining the classification of each pixel in the original image;
wherein the obtaining a target image from the denoised image according to the mask information of the target object comprises:
obtaining the target image from the denoised image according to the classification of each pixel in the original image, wherein the size of the target image is not larger than the size of the original image.

15. The intelligent terminal according to claim 11, wherein, after obtaining the target image from the denoised image according to the mask information of the target object, the processor further implements the following operation:
synthesizing a 3D image of the target object according to a plurality of 2D target images of the target object.

16. A storage device, storing program data; wherein the program data is executable to implement the following operations:
obtaining an original image, and obtaining mask information of a target object from the original image, wherein the mask information comprises classification information for foreground and background of the target object;
denoising the original image to obtain a denoised image of the original image; and
obtaining a target image from the denoised image according to the mask information of the target object.

17. The storage device according to claim 16, wherein the obtaining an original image and obtaining mask information of a target object from the original image comprises:
obtaining the original image, and obtaining initial mask information of the target object from the original image, wherein the initial mask information comprises classification information for initial foreground and background of the target object; and
performing fusion calculation on the initial mask information and the original image, and determining the mask information of the target object.

18. The storage device according to claim 17, wherein the performing fusion calculation on the initial mask information and the original image and determining the mask information of the target object comprises:
determining whether the classification information for the initial foreground and background is accurate; and
when the classification information is inaccurate, performing fusion calculation on the initial mask information and the original image, collecting the inaccurate classification information for the foreground and background based on the original image, and obtaining the mask information of the target object.

19. The storage device according to claim 16, wherein the obtaining an original image and obtaining mask information of a target object from the original image comprises:
obtaining the original image;
extracting feature information of the target object from the original image; and
classifying each pixel in the original image as the foreground or the background according to the feature information, and determining the classification of each pixel in the original image;
wherein the obtaining a target image from the denoised image according to the mask information of the target object comprises:
obtaining the target image from the denoised image according to the classification of each pixel in the original image, wherein the size of the target image is not larger than the size of the original image.

20. The storage device according to claim 16, wherein, after obtaining the target image from the denoised image according to the mask information of the target object, the program data further implements the following operation:
synthesizing a 3D image of the target object according to a plurality of 2D target images of the target object.
